(19) United States
(12) Patent Application Publication
(10) Pub. No.: US 2021/0045177 A1
(43) Pub. Date: Feb. 11, 2021

(54) HANDLING REPEATED NETWORK CONFIGURATION FAILURE

(71) Applicant: QUALCOMM Incorporated, San Diego, CA (US)

(72) Inventors: Kuo-Chun LEE, San Diego, CA (US); Arvind Vardarajan SANTHANAM, San Diego, CA (US); Subashini KRISHNAMURTHY, San Diego, CA (US); Vitaly DRAPKIN, San Diego, CA (US); Daniel AMERGA, San Diego, CA (US); Kanuganti Rajeswar REDDY, San Jose, CA (US); Osama LOTFALLAH, San Diego, CA (US); Shanshan WANG, San Diego, CA (US)

(21) Appl. No.: 16/533,409

(22) Filed: Aug. 6, 2019

(51) Int. Cl. H04W 76/18; H04W 48/02; H04W 76/15; H04W 24/10

(52) U.S. Cl. CPC H04W 76/18; H04W 48/02; H04W 88/02; H04W 24/10; H04W 76/15

(57) ABSTRACT

Various aspects of the present disclosure generally relate to wireless communication. In some aspects, a user equipment (UE) may determine that a network configuration procedure has failed a threshold number of times for a first radio access technology (RAT). The UE may perform a first action to prevent execution of the network configuration procedure until a timer has elapsed based at least in part on determining that the network configuration procedure has failed the threshold number of times. The first action may include transmitting a message that indicates that the UE does not have a capability to communicate using the first RAT, barring a cell or a tracking area of the first RAT or a second RAT that assists with establishing a radio access network connection for the first RAT, and/or refraining from reporting measurement results for the first RAT. Numerous other aspects are provided.

### FIELD OF THE DISCLOSURE

Aspects of the present disclosure generally relate to wireless communication and to techniques and apparatuses for handling repeated network configuration failure.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include determining that a network configuration procedure has failed a threshold number of times for a first radio access technology (RAT); and performing a first action to prevent execution of the network configuration procedure until a timer has elapsed based at least in part on determining that the network configuration procedure has failed the threshold number of times, wherein the first action comprises at least one of: transmitting a message that indicates that the UE does not have a capability to communicate using the first RAT, barring a cell or a tracking area of the first RAT or a second RAT that assists with establishing a radio access network connection for the first RAT, refraining from reporting measurement results for the first RAT, or a combination thereof.

In some aspects, a UE for wireless communication may include memory and one or more processors operatively coupled to the memory. The memory and the one or more processors may be configured to determine that a network configuration procedure has failed a threshold number of times for a first RAT; and perform a first action to prevent execution of the network configuration procedure until a timer has elapsed based at least in part on determining that the network configuration procedure has failed the threshold number of times, wherein the first action comprises at least one of: transmitting a message that indicates that the UE does not have a capability to communicate using the first RAT, barring a cell or a tracking area of the first RAT or a second RAT that assists with establishing a radio access network connection for the first RAT, refraining from reporting measurement results for the first RAT, or a combination thereof.

In some aspects, a non-transitory computer-readable medium may store one or more instructions for wireless communication. The one or more instructions, when executed by one or more processors of a UE, may cause the one or more processors to: determine that a network configuration procedure has failed a threshold number of times for a first RAT; and perform a first action to prevent execution of the network configuration procedure until a timer has elapsed based at least in part on determining that the network configuration procedure has failed the threshold number of times, wherein the first action comprises at least one of: transmitting a message that indicates that the UE does not have a capability to communicate using the first RAT, barring a cell or a tracking area of the first RAT or a second RAT that assists with establishing a radio access network connection for the first RAT, refraining from reporting measurement results for the first RAT, or a combination thereof.

In some aspects, an apparatus for wireless communication may include means for determining that a network configuration procedure has failed a threshold number of times for a first RAT; and means for performing a first action to prevent execution of the network configuration procedure until a timer has elapsed based at least in part on determining that the network configuration procedure has failed the threshold number of times, wherein the first action comprises at least one of: transmitting a message that indicates that the apparatus does not have a capability to communicate using the first RAT, barring a cell or a tracking area of the first RAT or a second RAT that assists with establishing a radio access network connection for the first RAT, refraining from reporting measurement results for the first RAT, or a combination thereof.

Aspects generally include a method, apparatus, system, computer program product, non-transitory computer-readable medium, user equipment, base station, wireless communication device, and processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3 is a diagram illustrating example 5G non-standalone (NSA) architectures, in accordance with various aspects of the present disclosure.

FIGS. 4-10 are diagrams illustrating examples of handling repeated network configuration failure, in accordance with various aspects of the present disclosure.

FIG. 11 is a diagram illustrating an example process performed, for example, by a user equipment, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

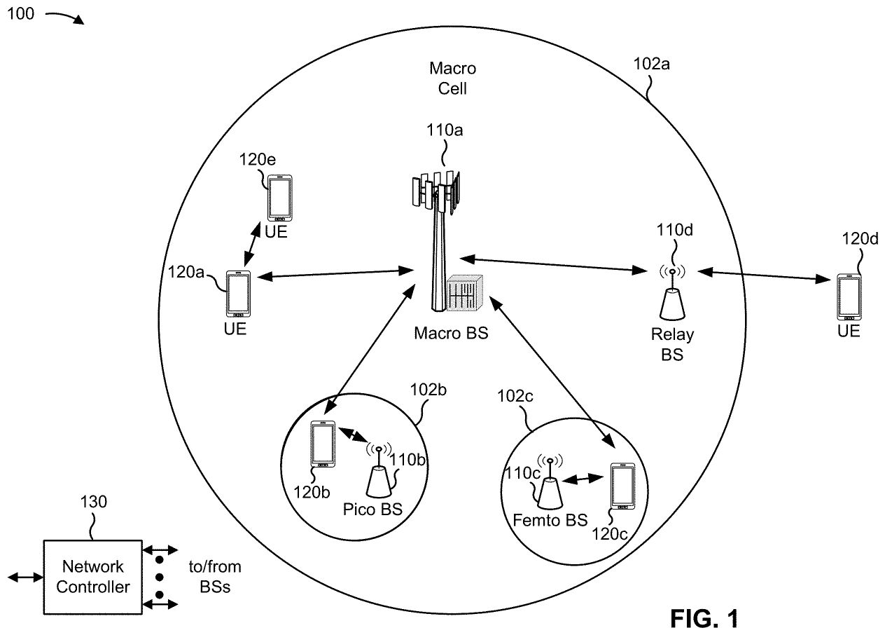

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. ABS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

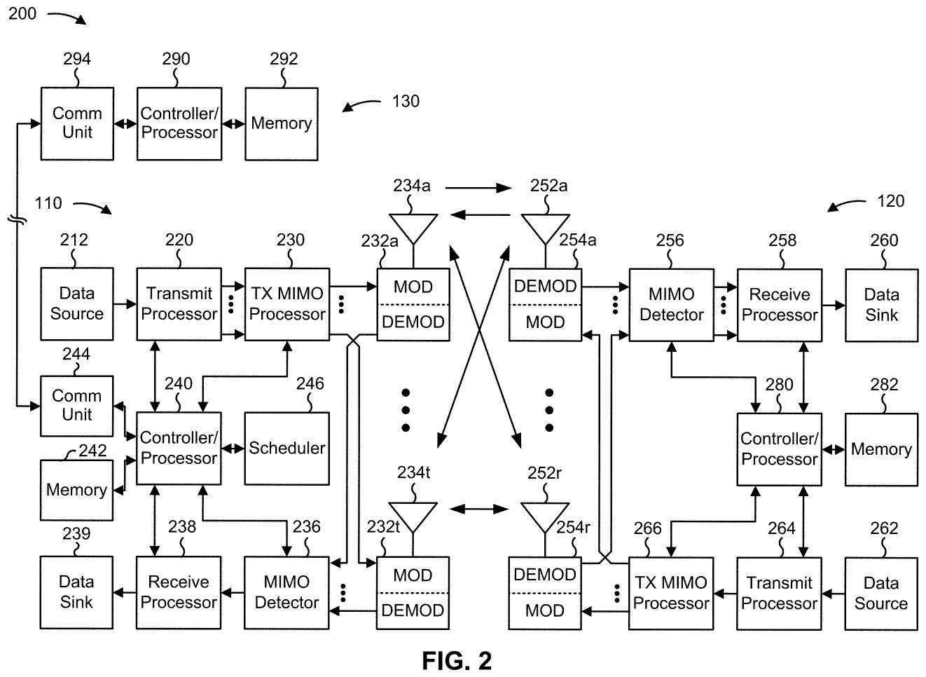

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

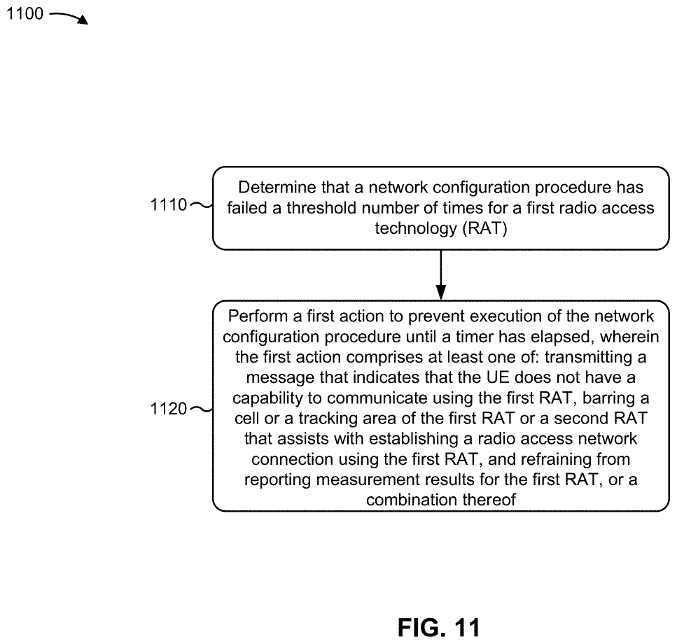

Controller/processor 240 of base station 110, controller/processor 280 of UE 120, and/or any other component(s) of FIG. 2 may perform one or more techniques associated with handling repeated network configuration failure, as described in more detail elsewhere herein. For example, controller/processor 240 of base station 110, controller/processor 280 of UE 120, and/or any other component(s) of FIG. 2 may perform or direct operations of, for example, process 1100 of FIG. 11 and/or other processes as described herein. Memories 242 and 282 may store data and program codes for base station 110 and UE 120, respectively. A scheduler 246 may schedule UEs for data transmission on the downlink and/or uplink.

In some aspects, UE 120 may include means for determining that a network configuration procedure has failed a threshold number of times for a first RAT; means for performing a first action to prevent execution of the network configuration procedure until a timer has elapsed based at least in part on determining that the network configuration procedure has failed the threshold number of times, wherein the first action comprises at least one of: transmitting a message that indicates that the apparatus does not have a capability to communicate using the first RAT, barring a cell or a tracking area of the first RAT or a second RAT that assists with establishing a radio access network connection for the first RAT, refraining from reporting measurement results for the first RAT, or a combination thereof; and/or the like. In some aspects, such means may include one or more components of UE 120 described in connection with FIG. 2.

As indicated above, FIG. 2 is provided as an example. Other examples may differ from what is described with regard to FIG. 2.

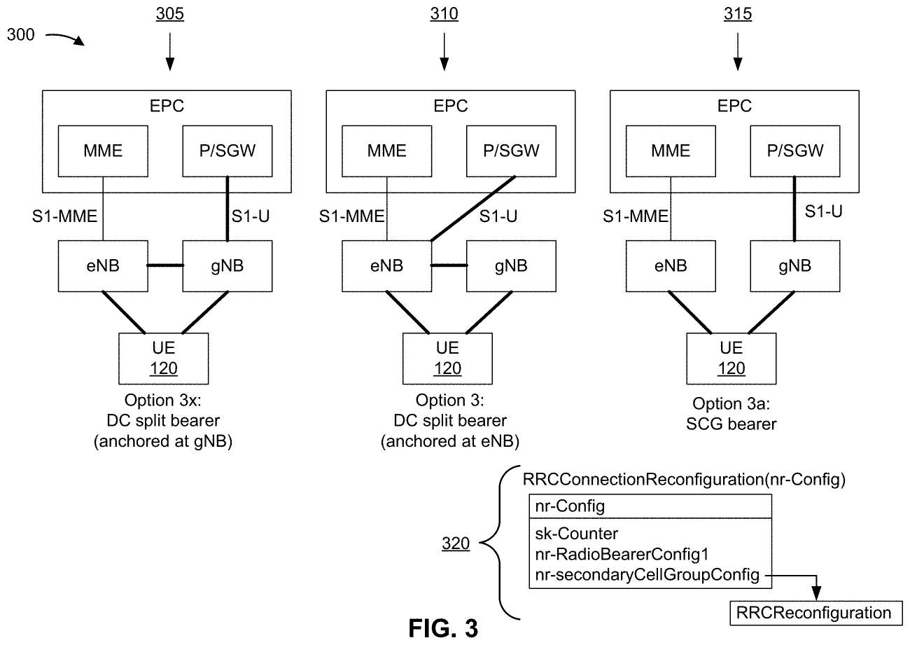

FIG. 3 is a diagram illustrating example 5G non-standalone (NSA) architectures 300, in accordance with various aspects of the present disclosure.

As shown in FIG. 3, in a 5G NSA mode, a UE 120 may communicate with both an eNB (e.g., a 4G base station 110) and a gNB (e.g., a 5G base station 110), and the eNB and the gNB may communicate (e.g., directly or indirectly) with a 4G/LTE core network, shown as an evolved packet core (EPC) that includes a mobility management entity (MME), a packet data network (PDN) gateway (PGW), a serving gateway (SGW), and/or the like. In FIG. 3, the PGW and the SGW are shown collectively as P/SGW.

As shown by reference number 305, in some aspects, a wireless network that permits operation in a 5G NSA mode may permit such operations using a first option (shown as option 3x) that uses dual connectivity with split bearers that are anchored at the gNB. In this case, the UE 120 may connect to both the eNB and the gNB using dual connectivity, and the gNB may aggregate and/or distribute traffic (e.g., data traffic) associated with the UE 120. In some aspects, the eNB may communicate with the MME in the 4G/LTE core network (e.g., via an S1-MME interface) to handle control plane information (e.g., non-access stratum (NAS) messages and/or the like). Additionally, or alternatively, the gNB may communicate with the PGW and/or the SGW in the 4G/LTE core network (e.g., via an S1-U interface) to handle user plane information (e.g., data traffic and/or the like). In this case, the eNB may transmit user plane information to the gNB (e.g., for transmission to the 4G/LTE core network) and/or may receive user plane information from the gNB (e.g., for transmission to the UE 120).

As shown by reference number 310, in some aspects, a wireless network that permits operation in a 5G NSA mode may permit such operations using a second option (shown as option 3) that uses dual connectivity with split bearers that are anchored at the eNB. In this case, the UE 120 may connect to both the eNB and the gNB using dual connectivity, and the eNB may aggregate and/or distribute traffic (e.g., data traffic) associated with the UE 120. In some aspects, the eNB may communicate with the MME in the 4G/LTE core network (e.g., via an S1-MME interface) to handle control plane information (e.g., non-access stratum messages and/or the like), and may communicate with the PGW and/or the SGW in the 4G/LTE core network (e.g., via an S1-U interface) to handle user plane information (e.g., data traffic and/or the like). In this case, the gNB may transmit user plane information to the eNB (e.g., for transmission to the 4G/LTE core network) and/or may receive user plane information from the eNB (e.g., for transmission to the UE 120).

As shown by reference number 315, in some aspects, a wireless network that permits operation in a 5G NSA mode may permit such operations using a third option (shown as option 3a) that uses a secondary cell group (SCG) bearer. In this case, the UE 120 may communicate with the eNB via a master cell group, and may communicate with the gNB via the secondary cell group. In some aspects, the master cell group may anchor a network connection between the UE 120 and the 4G/LTE core network (e.g., for mobility, coverage, control plane information, and/or the like), and the secondary cell group may be added as additional carriers to increase throughput (e.g., for data traffic, user plane information, and/or the like). In this case, the gNB and the eNB may not transfer user plane information between one another.

As shown by reference number 320, when a UE 120 establishes a connection with a gNB in a 5G NSA mode (e.g., via an SCG bearer, a secondary cell (SCell), a primary SCell (PSCell), and/or the like), the UE 120 may receive a radio resource control (RRC) message, such as an RRC connection reconfiguration message (e.g., shown as RRCConnectionReconfiguration (nr-Config)). The RRC connection reconfiguration message may include an NR configuration (nr-Config). The NR configuration may include, for example, a security key counter for NR (sk-Counter), a bearer configuration for NR (nr-RadioBearerConfig1), a configuration for an SCG with the gNB (nr-secondaryCellGroupConfig), and/or the like. The configuration for the SCG may include an RRC reconfiguration (RRCReconfiguration) to configure the SCG, such as physical (PHY) layer parameters for the SCG, media access control (MAC) layer parameters for the SCG, and/or the like.

The UE 120 may verify the NR configuration, and in some cases may determine that the NR configuration has an error that prevents the UE 120 from properly configuring a connection with the gNB. For example, the NR configuration may indicate a frequency that is incorrect or unsupported because LTE and NR can be on different bands (which may or may not be supported by the UE 120), may indicate one or more parameters that are not supported by a UE capability, may indicate a combination of frequency bands for LTE and NR (e.g., a first band for LTE and a second band for NR) that the UE 120 does not support, may indicate one or more parameters that cause an error for the UE 120 with respect to dual connectivity, and/or the like.

When a UE 120 detects an error associated with the NR configuration, the UE 120 may enter radio link failure (RLF) and may use an LTE connection re-establishment procedure to recover from RLF. Using this procedure, the UE 120 may re-establish a connection with the eNB, and the eNB may request the gNB to send another RRC connection reconfiguration message to the UE 120 (e.g., similar to the RRC message described above). In some cases, the new RRC connection reconfiguration message may be different from a previously transmitted RRC connection reconfiguration message, and may thereby resolve the error. However, in some cases, the RRC connection reconfiguration message (e.g., an NR configuration included in the message) may be associated with an error due to a mis-configuration of the gNB. As a result, the new RRC connection reconfiguration message may still cause an error. In this case, the UE 120 would repeatedly enter RLF, perform a connection re-establishment procedure, and experience an error. This would unnecessarily consume network resources (e.g., time resources, frequency resources, and/or the like) required to perform the re-establishment procedure, which may lead to lower throughput and higher latency (e.g., for other UEs 120 that could have used the consumed network resources). This would also unnecessarily consume resources of the UE 120, the eNB, and the gNB (e.g., processing resources, memory resources, battery power, and/or the like) required to repeatedly enter RLF, perform the connection re-establishment procedure, and/or detect the error. Some techniques and apparatuses described herein conserve network resources and device resources (e.g., resources of the UE 120, the eNB, and the gNB), such as by preventing the UE 120 from repeatedly entering RLF, performing a connection re-establishment procedure, and experiencing an error.

As indicated above, FIG. 3 is provided merely as an example. Other examples may differ from what is described with regard to FIG. 3.

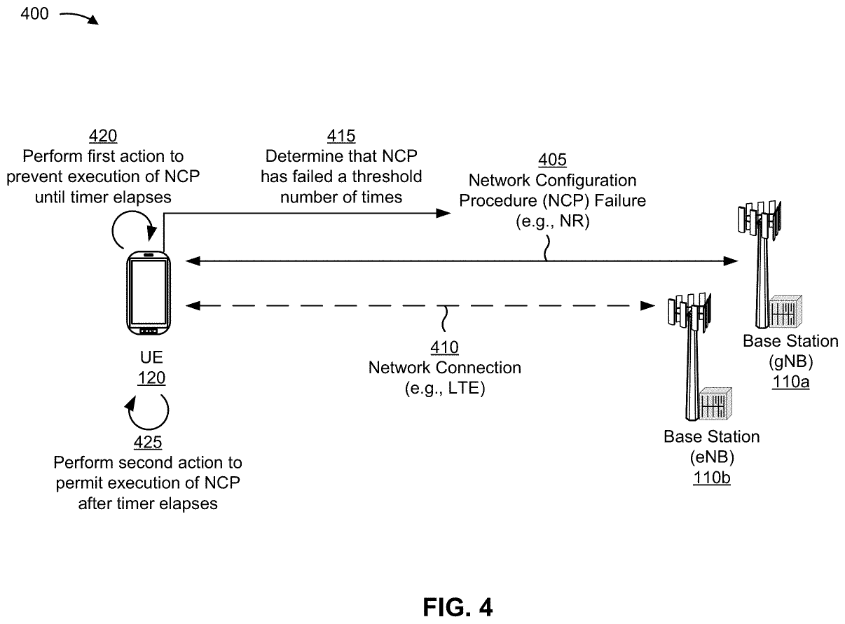

FIG. 4 is a diagram illustrating an example 400 of handling repeated network configuration failure, in accordance with various aspects of the present disclosure.

As shown in FIG. 4, a UE 120 may communicate with a first base station 110a (e.g., a gNB) that provides network access using a first radio access technology (RAT) (e.g., NR) and a second base station 110b (e.g., an eNB) that provides network access using a second RAT (e.g., LTE). For example, the UE 120 and the base stations 110 may operate in a 5G/NR NSA mode, as described above in connection with FIG. 3. In some aspects, the 5G/NSA mode may be referred to as an evolved universal terrestrial radio access (E-UTRA) and NR dual connectivity (ENDC) mode. Although some techniques are described herein in connection with a UE 120 operating in an NR NSA mode, in some aspects, these techniques may apply to a UE 120 operating in an NR standalone (SA) mode. Although the first RAT is an NR RAT and the second RAT is an LTE RAT in some examples described herein, other types of RATs are possible. In some aspects, the first RAT may be a later generation RAT and the second RAT may be an earlier generation RAT (e.g., that assists with establishing a radio access network connection for the first RAT). Similarly, although the first base station 110a is a gNB and the second base station 110b is an eNB in some examples described herein, other types of base stations 110 are possible. In some aspects, the first base station 110a may be a later generation base station 110 and the second base station 110b may be an earlier generation base station 110.

As shown by reference number 405, a network configuration procedure between the UE 120 and the gNB may fail for the first RAT, such as an NR RAT. For example, as described above in connection with FIG. 3, the UE 120 may determine that an NR configuration (e.g., in an RRC connection reconfiguration message received from the gNB as part of an RRC connection reconfiguration procedure) is associated with an error that prevents the UE 120 from properly configuring a connection with the gNB. For example, the NR configuration may indicate a frequency that is incorrect or unsupported by the UE 120, may indicate one or more parameters that are not supported by a UE capability, may indicate a combination of frequency bands for LTE and NR (e.g., a first band for LTE and a second band for NR) that the UE 120 does not support, may indicate one or more parameters that cause an error for the UE 120 with respect to dual connectivity and/or an NSA mode, and/or the like.

As shown by reference number 410, in some aspects, the UE 120 may have a network connection with an eNB via a second RAT, such as an LTE RAT. In this case, the failed network configuration procedure may be associated with an NSA mode. However, in some cases, the UE 120 may not have a network connection with the eNB and may have a network connection with the gNB, and the failed network configuration procedure may be associated with an SA mode.

As shown by reference number 415, the UE 120 may determine that the network configuration procedure has failed a threshold number of times for the first RAT. As described above in connection with FIG. 3, when the UE 120 detects an error associated with the NR configuration, the UE 120 may enter RLF and may use a connection re-establishment procedure to recover from RLF, which may trigger another network configuration procedure (e.g., another RRC connection reconfiguration message). In this case, rather than repeatedly entering RLF and reperforming the network configuration procedure, the UE 120 may determine that the network configuration procedure has failed a threshold number of times (e.g., one time, two times, three times, or the like). The UE 120 may store a counter to track the number of times that the network configuration procedure has failed. In some aspects, the UE 120 may reset the counter upon successful establishment of a connection using the network configuration procedure.

As shown by reference number 420, the UE 120 may perform a first action to prevent execution of the network configuration procedure until a timer has elapsed (e.g., expired). The UE 120 may perform the first action based at least in part on determining that the network configuration procedure has failed the threshold number of times. For example, when the UE 120 determines that the network configuration procedure has failed the threshold number of times, the UE 120 may initiate a timer and may perform a first action to prevent execution of the network configuration procedure while the timer is running. In some aspects, the first action may involve a communication with the first base station 110a and/or the second base station 110b. Additionally, or alternatively, the first action may include an autonomous action performed by the UE 120 (e.g., without communicating with the first base station 110a and/or the second base station 110b).

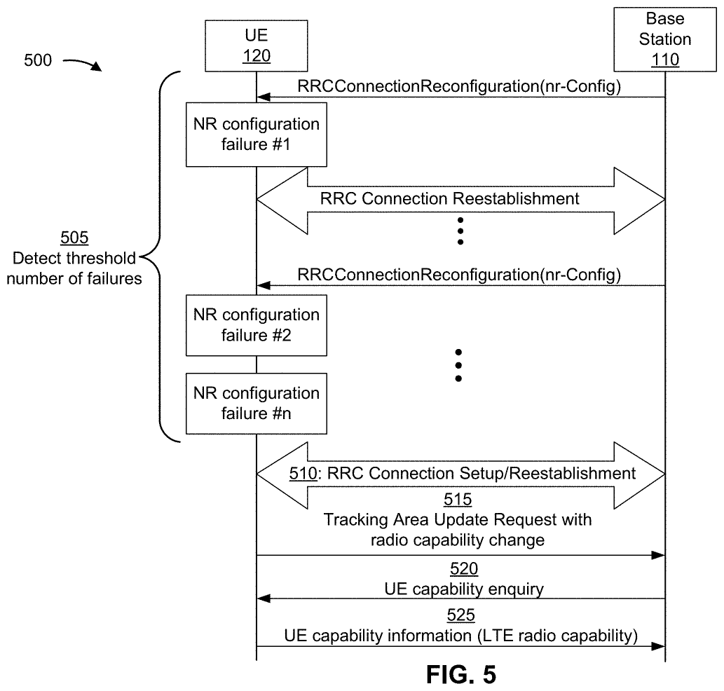

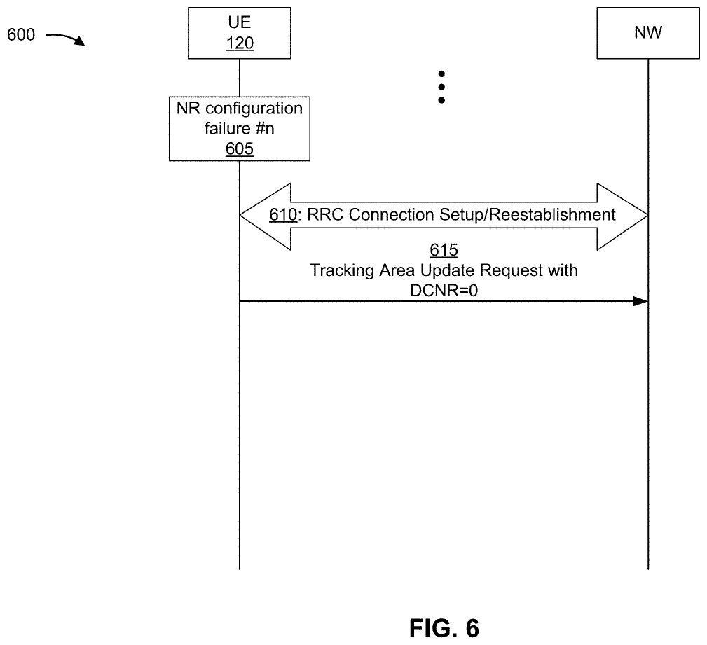

In some aspects, the first action may include transmitting a message that indicates that the UE 120 does not have a capability to communicate using the first RAT (even though the UE 120 may have such a capability). For example, as described in more detail below in connection with FIG. 5, the UE 120 may perform a tracking area update procedure that includes transmitting a UE capability information message that indicates that the UE 120 does not have a radio capability for the first RAT and/or that the UE 120 does not have a capability for dual connectivity with the first RAT and the second RAT (even though the UE 120 may have one or both of these capabilities). Additionally, or alternatively, as described in more detail below in connection with FIG. 6, the UE 120 may transmit a tracking area update request that indicates that the UE 120 does not have a UE network capability that supports dual connectivity for the first RAT and the second RAT (even though the UE 120 may have such a capability). In this way, the UE 120 may prevent the network configuration procedure from being performed.

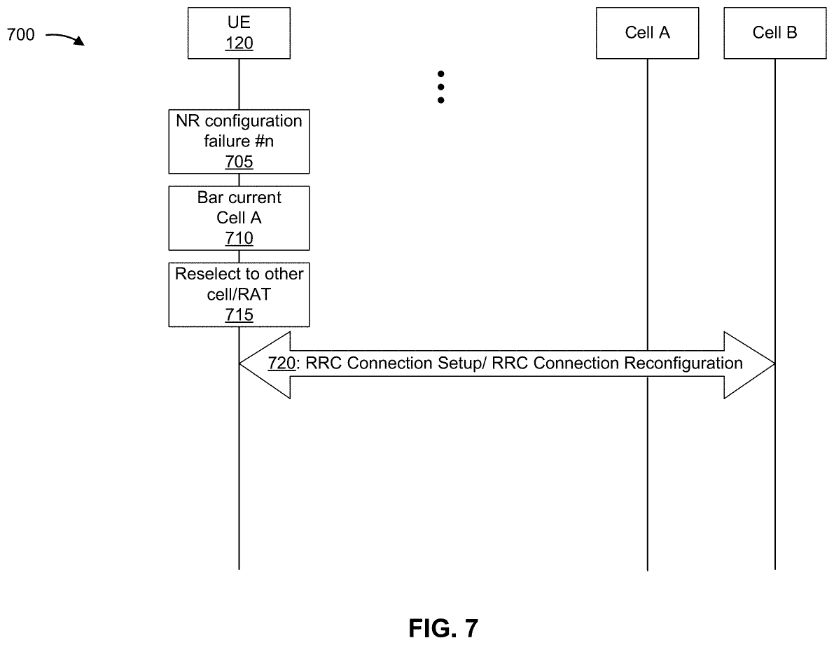

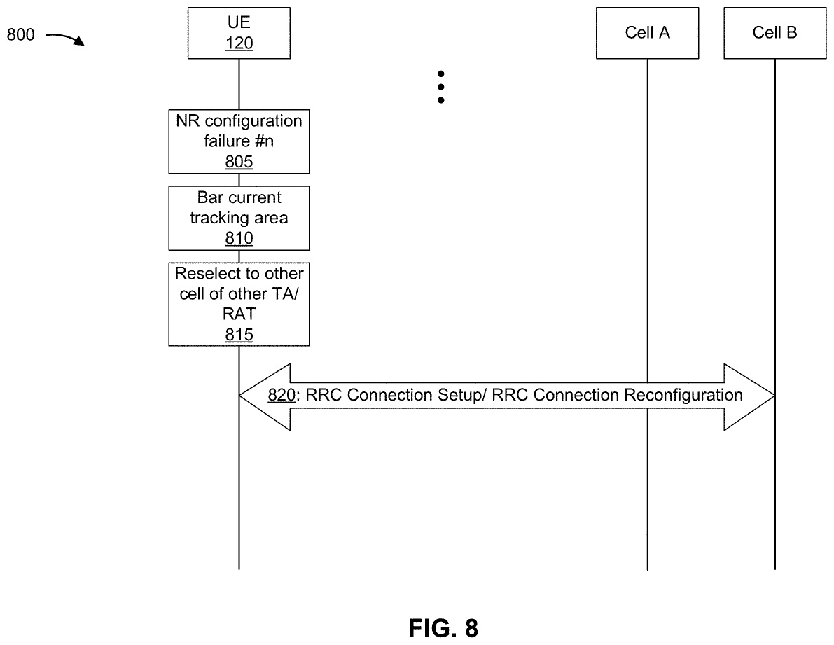

Additionally, or alternatively, the first action may include barring a cell or a tracking area of the first RAT or the second RAT. For example, as described in more detail below in connection with FIG. 7, the UE 120 may bar a cell of the first RAT and/or may bar a cell of the second RAT. Additionally, or alternatively, as described in more detail below in connection with FIG. 8, the UE 120 may bar a tracking area of the first RAT and/or may bar a tracking area of the second RAT. In this way, the UE 120 may prevent the network configuration procedure from being performed.

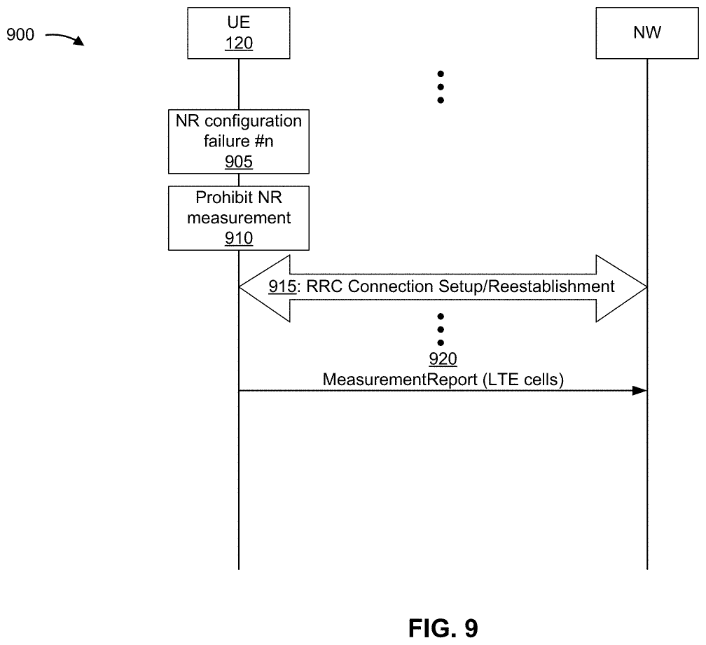

Additionally, or alternatively, the first action may include refraining from reporting measurement results for the first RAT, as described in more detail below in connection with FIG. 9. In this way, the UE 120 may prevent the network configuration procedure from being performed.

As shown by reference number 425, the UE 120 may perform a second action to permit execution of the network configuration procedure based at least in part on determining that the timer has elapsed. For example, the UE 120 may determine that the timer has elapsed (e.g., expired). Once the timer has elapsed, the UE 120 may perform the second action to permit execution of the network configuration procedure. In some aspects, the second action may involve a communication with the first base station 110a and/or the second base station 110b. Additionally, or alternatively, the second action may include an autonomous action performed by the UE 120 (e.g., without communicating with the first base station 110a and/or the second base station 110b).

In some aspects, the second action may include transmitting a message that indicates that the UE 120 has a capability to communicate using the first RAT. For example, as described in more detail below in connection with FIG. 5, the UE 120 may perform a tracking area update procedure that includes transmitting a UE capability information message that indicates that the UE 120 has a radio capability for the first RAT and/or that the UE 120 has a capability for dual connectivity with the first RAT and the second RAT. Additionally, or alternatively, as described in more detail below in connection with FIG. 6, the UE 120 may transmit a tracking area update request that indicates that the UE 120 has a UE network capability that supports dual connectivity for the first RAT and the second RAT. In this way, the UE 120 may permit the network configuration procedure to be performed.

Additionally, or alternatively, the second action may include debarring a cell or a tracking area of the first RAT or the second RAT. For example, as described in more detail below in connection with FIG. 7, the UE 120 may debar a cell of the first RAT and/or may debar a cell of the second RAT. Additionally, or alternatively, as described in more detail below in connection with FIG. 8, the UE 120 may debar a tracking area of the first RAT and/or may debar a tracking area of the second RAT. In this way, the UE 120 may permit the network configuration procedure to be performed.

Additionally, or alternatively, the second action may include reporting one or more measurement results for the first RAT (and/or resuming such reporting), as described in more detail below in connection with FIG. 9. In this way, the UE 120 may permit the network configuration procedure to be performed.

By preventing the network configuration procedure from being performed (e.g., temporarily while the timer is running), the UE 120 may conserve network resources and device resources (e.g., of the UE 120, the eNB, the gNB, and/or the like) that would otherwise be consumed due to repeated attempts to perform the network configuration procedure that result in failure (e.g., due to a mis-configuration of the gNB), as described above in connection with FIG. 3. Furthermore, by retrying the network configuration procedure after the time elapses, the UE 120 may achieve performance improvements associated with dual connectivity and/or connectivity with the first RAT (e.g., an NR RAT) if the network configuration procedure succeeds with the retry (e.g., due to a mis-configuration of the gNB being resolved), such as increased data throughput, lower latency, and/or the like.

As indicated above, FIG. 4 is provided as an example. Other examples may differ from what is described with respect to FIG. 4.

FIG. 5 is a diagram illustrating another example 500 of handling repeated network configuration failure, in accordance with various aspects of the present disclosure.

As described above in connection with FIG. 4, a UE 120 may perform a first action to prevent execution of a network configuration procedure, such as an RRC connection reconfiguration procedure (e.g., for NR NSA or NR SA). In example 500, the UE 120 prevents the network configuration procedure from being performed by performing a tracking area update procedure that includes transmitting a UE capability information message that indicates that the UE 120 does not have a radio capability for the first RAT and/or that the UE 120 does not have a capability for dual connectivity with the first RAT and the second RAT.

As shown by reference number 505, the UE 120 may determine that the network configuration procedure has failed a threshold number of times, as described above in connection with FIG. 4. As shown, a base station 110 (e.g., an NR base station, such as a gNB) may transmit, to the UE 120, an RRC connection reconfiguration message with an NR configuration for the UE 120, and the UE 120 may detect a configuration failure. Based at least in part on the configuration failure, the UE 120 and the base station 110 may perform an RRC connection re-establishment procedure. The base station 110 may transmit, to the UE 120, another RRC connection reconfiguration message with an NR configuration for the UE 120, and the UE 120 may detect another configuration failure. This may continue until the UE 120 detects a threshold number of configuration failures, shown as n failures. In example 500, n is greater than two, but in some aspects, n may be less than or equal to two. As shown by reference number 510, after the UE 120 detects the threshold number of failures, the UE 120 and the base station 110 may perform an RRC connection setup procedure and/or an RRC connection re-establishment procedure.

As shown by reference number 515, the UE 120 may transmit, to the base station 110, a tracking area update request that includes a “UE radio capability information update needed” information element (IE). This IE may signal to the base station 110 that a radio capability of the UE 120 has changed. As shown by reference number 520, when this IE is included in the tracking area update request, the IE may trigger the base station 110 to transmit, to the UE 120, a UE capability enquiry. As shown by reference number 525, the UE capability enquiry may trigger the UE 120 to transmit a UE capability information message that indicates that the UE 120 does not have a radio capability for the first RAT and/or that the UE 120 does not have a radio capability for dual connectivity with the first RAT and the second RAT. For example, as shown, the UE capability information message may indicate that the UE 120 has a capability to communicate using only the second RAT (e.g., LTE) and not the first RAT (e.g., NR) nor ENDC. In some aspects, the UE 120 may disable a radio capability for the first RAT in addition to reporting that the UE 120 does not have a radio capability for the first RAT, which may further conserve resources of the UE 120.

As a result of receiving the UE capability information message, the base station 110 will not attempt further network configuration procedures for NR (e.g., will not transmit additional RRC connection reconfiguration messages for NR, will not attempt to add a PSCell for the UE 120, and/or the like). In this way, network resources, resources of the UE 120, and resources of the base station 110 may be conserved.

In some aspects, if the UE 120 receives an instruction from the base station 110 to add an NR cell (sometimes referred to as a blind cell addition request), the UE 120 may ignore the request. A blind cell addition request may refer to a network instruction for the UE 120 to add a cell when the UE 120 has not reported a signal quality of the cell (e.g., the UE 120 has not transmitted a measurement report for the cell). For example, the UE 120 may refrain from adding an NR cell, such as an NR PSCell. However, the UE 120 may transmit a reconfiguration complete message based at least in part on the instruction (e.g., to prevent additional 4G RLF due to an NR configuration failure). In some aspects, the UE 120 may trigger secondary cell group radio link failure after transmitting the reconfiguration complete message.

In some aspects, the UE 120 may start a timer based at least in part on detecting the threshold number of failures and/or performing the first action (e.g., disabling a radio capability for the first RAT, transmitting or receiving one or more of the messages described above, and/or the like). In some aspects, the timer may have a relatively long duration, such as one day, one week, one month, and/or the like because the threshold number of configuration failures may occur due to a mis-configuration of the base station 110, which may take a relatively long time to correct.

As described above in connection with FIG. 4, after the timer elapses, the UE 120 may perform a second action to permit execution of a network configuration procedure. In example 500, the UE 120 permits the network configuration procedure to be performed by performing a tracking area update procedure that includes transmitting a UE capability information message that indicates that the UE 120 has a radio capability for the first RAT and/or that the UE 120 has a capability for dual connectivity with the first RAT and the second RAT.

For example, the UE 120 may determine that the timer has elapsed, and may transmit a tracking area update request that includes the “UE radio capability information update needed” IE based at least in part on determining that the timer has elapsed. When the base station 110 receives the tracking area update request with this IE, the base station 110 may transmit, to the UE 120, a UE capability enquiry. When the UE 120 receives the UE capability enquiry, the UE 120 may transmit, to the base station 110, a UE capability information message that indicates that the UE 120 has a radio capability to communicate using the first RAT and/or to communicate using dual connectivity with the first RAT and the second RAT. In some aspects, the UE 120 may enable a radio capability for the first RAT (e.g., when such a capability was previously disabled).

As a result of receiving the UE capability information message, the base station 110 may attempt further network configuration procedures for NR (e.g., may transmit additional RRC connection reconfiguration messages for NR, may attempt to add a PSCell for the UE 120, and/or the like). In this way, performance improvements associated with NR may be achieved if the mis-configuration is resolved before the timer elapses.

The tracking area update procedure described in connection with FIG. 5 is typically a non-access stratum (NAS) procedure used to notify a core network that a tracking area of the UE 120 has changed. However, as described herein, the tracking area update procedure can be used to notify the base station 110 to update a UE radio capability, which can be used to prevent the network configuration procedure from being performed. Because the technique described in connection with FIG. 5 is a RAN-based technique (e.g., that occurs at the base station 110 rather than the core network), this technique may be capable of more quickly preventing additional network configuration messages from being transmitted as compared to a core network-based technique (e.g., that would require additional messaging between the base station 110 and a core network).

As indicated above, FIG. 5 is provided as an example. Other examples may differ from what is described with respect to FIG. 5.

FIG. 6 is a diagram illustrating another example 600 of handling repeated network configuration failure, in accordance with various aspects of the present disclosure.

As described above in connection with FIG. 4, a UE 120 may perform a first action to prevent execution of a network configuration procedure, such as an RRC connection reconfiguration procedure (e.g., for NR NSA or NR SA). In example 600, the UE 120 prevents the network configuration procedure from being performed by transmitting a tracking area update request that indicates that the UE 120 does not have a UE network capability that supports dual connectivity for the first RAT and the second RAT.

As shown by reference number 605, the UE 120 may determine that the network configuration procedure has failed a threshold number of times, as described above in connection with FIG. 4 and FIG. 5. As shown by reference number 610, after the UE 120 detects the threshold number of failures, the UE 120 and the base station 110 (e.g., an NR base station 110, a gNB, and/or the like) may perform an RRC connection setup procedure and/or an RRC connection re-establishment procedure.

As shown by reference number 615, the UE 120 may transmit, to the base station 110, a tracking area update request that indicates that the UE 120 does not have a UE network capability that supports dual connectivity for the first RAT and the second RAT (e.g., an ENDC capability). In some aspects, the UE 120 may disable a radio capability for the first RAT in addition to reporting that the UE 120 does not have a UE network capability that supports dual connectivity for the first RAT and the second RAT, which may further conserve resources of the UE 120. For example, the UE 120 may set a dual connectivity with NR (DCNR) bit, included in the tracking area update request, to a first value (e.g., 0) that indicates that the UE 120 does not have a UE network capability to support ENDC (e.g., DCNR). Additionally, or alternatively, the UE 120 may set a bit that indicates whether the UE 120 supports a connection with a 5G core network (e.g., an N1mode bit) to a first value (e.g., 0) that indicates that the UE 120 does not have a UE network capability to support NR SA mode (e.g., via a NR connection with a 5G core network).

As a result of receiving the UE tracking area update request, the base station 110 will not attempt further network configuration procedures for NR (e.g., will not transmit additional RRC connection reconfiguration messages for NR, will not attempt to add a PSCell for the UE 120, and/or the like). In this way, network resources, resources of the UE 120, and resources of the base station 110 may be conserved.

In some aspects, if the UE 120 receives an instruction from the base station 110 to add an NR cell (sometimes referred to as a blind cell addition request), the UE 120 may ignore the request. A blind cell addition request may refer to a network instruction for the UE 120 to add a cell when the UE 120 has not reported a signal quality of the cell (e.g., the UE 120 has not transmitted a measurement report for the cell). For example, the UE 120 may refrain from adding an NR cell, such as an NR PSCell. However, the UE 120 may transmit a reconfiguration complete message based at least in part on the instruction (e.g., to prevent additional 4G RLF due to an NR configuration failure). In some aspects, the UE 120 may trigger secondary cell group radio link failure after transmitting the reconfiguration complete message.

In some aspects, the UE 120 may start a timer based at least in part on detecting the threshold number of failures and/or performing the first action (e.g., disabling a radio capability for the first RAT, transmitting or receiving one or more of the messages described above, and/or the like), as described elsewhere herein.

As described above in connection with FIG. 4, after the timer elapses, the UE 120 may perform a second action to permit execution of a network configuration procedure. In example 600, the UE 120 permits the network configuration procedure to be performed by transmitting a tracking area update request that indicates that the UE 120 has a UE network capability that supports dual connectivity for the first RAT and the second RAT. For example, the UE 120 may determine that the timer has elapsed, and may transmit a tracking area update request with a DCNR bit set to a second value (e.g., 1) that indicates that the UE 120 has a UE network capability to support ENDC (e.g., DCNR). Additionally, or alternatively, the UE 120 may set a bit that indicates whether the UE 120 supports a connection with a 5G core network (e.g., an N1mode bit) to a second value (e.g., 1) that indicates that the UE 120 has a UE network capability to support NR SA mode (e.g., via a NR connection with a 5G core network).

As a result of receiving the tracking area update request, the base station 110 may attempt further network configuration procedures for NR (e.g., may transmit additional RRC connection reconfiguration messages for NR, may attempt to add a PSCell for the UE 120, and/or the like). In this way, performance improvements associated with NR may be achieved if the mis-configuration is resolved before the timer elapses.

The tracking area update procedure described in connection with FIG. 6 is a non-access stratum (NAS) procedure (e.g., a core network-based technique) used to notify a core network that a tracking area of the UE 120 has changed. In this case, the tracking area update request may notify a core network of the capability change of the UE 120, and the core network may notify the base station 110. The technique of FIG. 6 may use less signaling overhead than some other techniques described herein (e.g., in connection with FIG. 5).

As indicated above, FIG. 6 is provided as an example. Other examples may differ from what is described with respect to FIG. 6.

FIG. 7 is a diagram illustrating another example 700 of handling repeated network configuration failure, in accordance with various aspects of the present disclosure.

As described above in connection with FIG. 4, a UE 120 may perform a first action to prevent execution of a network configuration procedure, such as an RRC connection reconfiguration procedure (e.g., for NR NSA or NR SA). In example 700, the UE 120 prevents the network configuration procedure from being performed by barring a cell of the first RAT and/or by barring a cell of the second RAT. As shown by reference number 705, the UE 120 may determine that the network configuration procedure has failed a threshold number of times, as described above.

As shown by reference number 710, based at least in part on determining that the network configuration procedure has failed a threshold number of times, the UE 120 may bar the current cell (shown as Cell A) on which the UE 120 is camped (e.g., via which the UE 120 is connected to a base station 110). In some aspects, the UE 120 may bar the current cell based at least in part on a determination that the UE 120 detects multiple cells (e.g., of a RAT used for the current cell and/or a lower generation RAT than the RAT used for the current cell). As shown by reference number 715, the UE 120 may select another cell (shown as Cell B), which may be a cell that uses the same RAT as the current cell or a cell that uses a different RAT (e.g., a lower generation RAT, such as a 3G RAT, a 2G RAT, and/or the like).

In some aspects, the UE 120 may bar a cell of the second RAT (e.g., an LTE cell). For example, an LTE cell may be associated with a mis-configuration for ENDC, and another LTE cell may have a proper configuration for ENDC. In this case, the UE 120 may select a different cell of the second RAT (e.g., LTE), which may have a proper configuration for dual connectivity with the first RAT. In this way, the UE 120 can attempt ENDC on other LTE cells. Alternatively, the UE 120 may select a cell of a third RAT, such as a lower generation RAT (e.g., a 3G RAT, a 2G RAT, and/or the like).

In some aspects, the UE 120 may bar a cell of the first RAT (e.g., an NR cell). For example, an NR cell may be associated with a mis-configuration for NR SA mode, and another NR cell may have a proper configuration for NR SA mode. In this case, the UE 120 may select a different cell of the first RAT (e.g., NR), which may have a proper configuration with the first RAT. In this way, the UE 120 can attempt NR SA mode on other NR cells.

As shown by reference number 720, after the UE 120 selects another cell, the UE 120 and the base station 110 (e.g., an NR base station 110, a gNB, and/or the like) may perform an RRC connection setup procedure and/or an RRC connection re-establishment procedure for that cell (shown as Cell B). By barring the current cell and selecting a new cell, the UE 120 may prevent network configuration messages from being transmitted for the current cell, thereby conserving network resources, resources of the UE 120, and resources of the base station 110. Furthermore, if the new cell has a proper configuration for NR SA mode, then the base station 110 and the UE 120 may be able to establish an NR SA connection, such as by using the network configuration procedure described elsewhere herein in connection with the new NR cell.

In some aspects, the UE 120 may start a timer based at least in part on detecting the threshold number of failures and/or performing the first action (e.g., barring a cell, selecting a new cell, and/or the like), as described elsewhere herein. In some aspects, the timer may be cell-specific (e.g., may be used for only the barred cell, and not any other cells, to indicate when to debar the barred cell).

As described above in connection with FIG. 4, after the timer elapses, the UE 120 may perform a second action to permit execution of a network configuration procedure. In example 700, the UE 120 permits the network configuration procedure to be performed by debarring a cell of the first RAT and/or debarring a cell of the second RAT. For example, when the UE 120 bars a cell, the UE 120 may debar that cell after the timer elapses. In some aspects (e.g., if the debarred cell is better than the reselected cell), the base station 110 may attempt further network configuration procedures for NR on the debarred cell (e.g., may transmit additional RRC connection reconfiguration messages for NR, may attempt to add a PSCell for the UE 120, and/or the like). In this way, performance improvements associated with NR may be achieved if the mis-configuration is resolved before the timer elapses. The tracking area update procedure described in connection with FIG. 7 may assist with bypassing cell-specific ENDC and/or NR SA issues.

As indicated above, FIG. 7 is provided as an example. Other examples may differ from what is described with respect to FIG. 7.

FIG. 8 is a diagram illustrating another example 800 of handling repeated network configuration failure, in accordance with various aspects of the present disclosure.

As described above in connection with FIG. 4, a UE 120 may perform a first action to prevent execution of a network configuration procedure, such as an RRC connection reconfiguration procedure (e.g., for NR NSA or NR SA). In example 800, the UE 120 prevents the network configuration procedure from being performed by barring a tracking area of the first RAT and/or barring a tracking area of the second RAT. As shown by reference number 805, the UE 120 may determine that the network configuration procedure has failed a threshold number of times, as described above.

As shown by reference number 810, based at least in part on determining that the network configuration procedure has failed a threshold number of times, the UE 120 may bar the current tracking area (e.g., associated with a first cell, shown as Cell A) associated with the UE 120 (e.g., a tracking area in which the UE 120 is located). In some aspects, the UE 120 may bar the current tracking area based at least in part on a determination that the UE 120 detects a cell in a different tracking area (e.g., of a same RAT used for the current cell and/or a lower generation RAT than the RAT used for the current cell). As shown by reference number 815, the UE 120 may select another cell (a second cell, shown as Cell B) in a different tracking area than the barred tracking area, which may be a second cell that uses the same RAT as the first cell of the barred tracking area or a different RAT than the first cell (e.g., a lower generation RAT, such as a 3G RAT, a 2G RAT, and/or the like).

In some aspects, the UE 120 may bar a tracking area of the second RAT (e.g., an LTE cell). For example, a first LTE tracking area may be associated with a mis-configuration for ENDC, and a second LTE tracking area may have a proper configuration for ENDC. In this case, the UE 120 may select a different cell of the second RAT (e.g., LTE) in the second tracking area, which may have a proper configuration for dual connectivity with the first RAT. In this way, the UE 120 can attempt ENDC on other LTE cells. Alternatively, the UE 120 may select a cell in a tracking area of a third RAT, such as a lower generation RAT (e.g., a 3G RAT, a 2G RAT, and/or the like).

In some aspects, the UE 120 may bar a tracking area of the first RAT (e.g., an NR cell). For example, a first NR tracking area may be associated with a mis-configuration for NR SA mode, and a second NR tracking area may have a proper configuration for NR SA mode. In this case, the UE 120 may select a different cell of the first RAT (e.g., NR) in the second tracking area, which may have a proper configuration for dual connectivity with the second RAT. In this way, the UE 120 can attempt NR SA on other NR cells.

As shown by reference number 820, after the UE 120 selects a cell of a second tracking area, the UE 120 and the base station 110 (e.g., an NR base station 110, a gNB, and/or the like) may perform an RRC connection setup procedure and/or an RRC connection re-establishment procedure for that cell (shown as Cell B). By barring the current tracking area and selecting a new cell in a new tracking area, the UE 120 may prevent network configuration messages from being transmitted for the current cell, thereby conserving network resources, resources of the UE 120, and resources of the base station 110. Furthermore, if the new tracking area has a proper configuration for NR SA mode, then the base station 110 and the UE 120 may be able to establish an NR SA connection, such as by using the network configuration procedure described elsewhere herein in connection with the new cell.

In some aspects, the UE 120 may start a timer based at least in part on detecting the threshold number of failures and/or performing the first action (e.g., barring a tracking area, selecting a new cell in a new tracking area, and/or the like), as described elsewhere herein. In some aspects, the timer may be tracking area-specific (e.g., may be used for only the barred tracking area, and not any other tracking areas, to indicate when to debar the barred tracking area).

As described above in connection with FIG. 4, after the timer elapses, the UE 120 may perform a second action to permit execution of a network configuration procedure. In example 800, the UE 120 permits the network configuration procedure to be performed by debarring a tracking area of the first RAT and/or debarring a tracking area of the second RAT. For example, when the UE 120 bars a tracking area, the UE 120 may debar that tracking area after the timer elapses. In some aspects (e.g., if a cell of the debarred tracking area is better than the reselected cell), the base station 110 may attempt further network configuration procedures for NR on a cell of the debarred tracking area (e.g., may transmit additional RRC connection reconfiguration messages for NR, may attempt to add a PSCell for the UE 120, and/or the like). In this way, performance improvements associated with NR may be achieved if the mis-configuration is resolved before the timer elapses. The tracking area update procedure described in connection with FIG. 8 may assist with bypassing tracking area-specific ENDC and/or NR SA issues, which may be more likely than cell-specific ENDC and/or NR SA issues because network deployments are typically tracking-area specific, which may affect all of the cells (e.g., multiple cells) included in the tracking area.

As indicated above, FIG. 8 is provided as an example. Other examples may differ from what is described with respect to FIG. 8.

FIG. 9 is a diagram illustrating another example 900 of handling repeated network configuration failure, in accordance with various aspects of the present disclosure.

As described above in connection with FIG. 4, a UE 120 may perform a first action to prevent execution of a network configuration procedure, such as an RRC connection reconfiguration procedure (e.g., for NR NSA or NR SA). In example 900, the UE 120 prevents the network configuration procedure from being performed by refraining from reporting measurement results for a first RAT (e.g., an NR RAT). As shown by reference number 905, the UE 120 may determine that the network configuration procedure has failed a threshold number of times, as described above.

As shown by reference number 910, based at least in part on determining that the network configuration procedure has failed a threshold number of times, the UE 120 may refrain from reporting measurement results for the first RAT. For example, the UE 120 may be connected to a cell of an LTE RAT, and may refrain from measuring reference signals on one or more neighbor cells of an NR RAT, and/or the UE 120 may refrain from reporting measurement results of measuring those reference signals.

As shown by reference number 915, the UE 120 and the base station 110 (e.g., an NR base station 110, a gNB, and/or the like) may perform an RRC connection setup procedure and/or an RRC connection re-establishment procedure. By refraining from reporting measurement results for cells of the first RAT (e.g., NR cells), the UE 120 may establish a connection using the second RAT (e.g., an LTE RAT) and may prevent network configuration messages from being transmitted for the first RAT, thereby conserving network resources, resources of the UE 120, and resources of the base station 110. For example, as shown by reference number 920, the UE 120 may report measurements for the second RAT (e.g., for LTE cells) and not for the first RAT.

In some aspects, the UE 120 may start a timer based at least in part on detecting the threshold number of failures and/or performing the first action (e.g., configuring the UE 120 to refrain from measuring cells of the first RAT, configuring the UE 120 to refrain from reporting measurements for the first RAT, and/or the like), as described elsewhere herein. In some aspects, the timer may be cell-specific (e.g., may be used for only the serving cell for which NR neighbor cell measurements are disabled).

As described above in connection with FIG. 4, after the timer elapses, the UE 120 may perform a second action to permit execution of a network configuration procedure. In example 900, the UE 120 permits the network configuration procedure to be performed by enabling measurement and/or reporting of one or more measurement results for the first RAT. In this way, performance improvements associated with NR may be achieved if the mis-configuration is resolved before the timer elapses.

The tracking area update procedure described in connection with FIG. 9 may conserve additional resources of the UE 120 by disabling measurement of cells of the first RAT and/or disabling transmission of measurement results, may conserve network resources that would otherwise be used for such transmissions, and/or the like.

As indicated above, FIG. 9 is provided as an example. Other examples may differ from what is described with respect to FIG. 9.

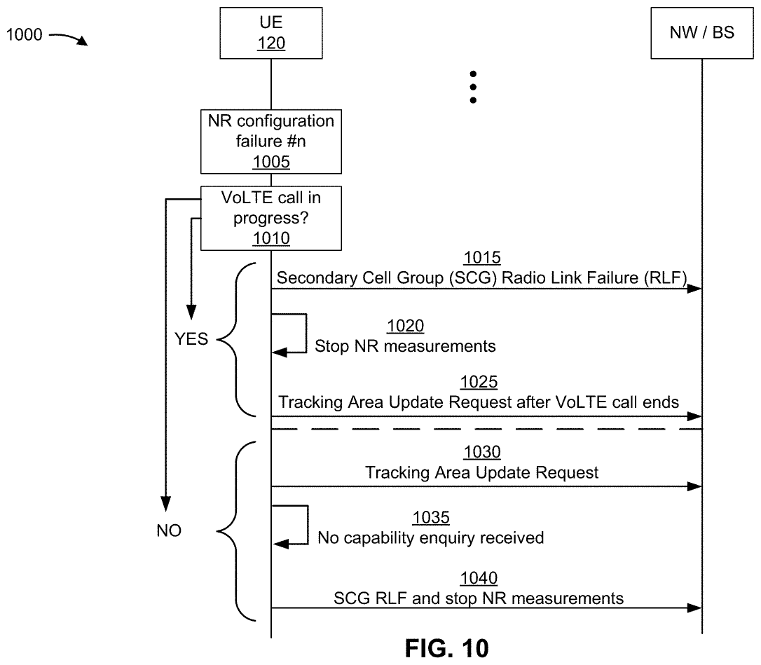

FIG. 10 is a diagram illustrating another example 1000 of handling repeated network configuration failure, in accordance with various aspects of the present disclosure.

As described above in connection with FIG. 4, a UE 120 may perform a first action to prevent execution of a network configuration procedure, such as an RRC connection reconfiguration procedure (e.g., for ENDC, NR NSA, or NR SA). In example 1000, the UE 120 prevents the network configuration procedure from being performed by triggering secondary cell group (SCG) radio link failure (RLF), by refraining from performing (e.g., stopping) one or more NR measurements, and/or by performing a tracking area update (TAU) procedure. As shown by reference number 1005, the UE 120 may determine that the network configuration procedure has failed a threshold number of times (e.g., within a time period), as described above. In some aspects, the threshold number may be one. In some aspects, the threshold number may be greater than one.

As shown by reference number 1010, based at least in part on determining that the network configuration procedure has failed a threshold number of times, the UE 120 may determine whether the UE 120 has a Voice over Long Term Evolution (VoLTE) call in progress (e.g., whether the UE 120 is currently connected on a VoLTE call).

As shown by reference number 1015, if the UE 120 is connected on a VoLTE call when the network configuration procedure has failed the threshold number of times, then the UE 120 may trigger SCG RLF. For example, the UE 120 may signal SCG RLF to a base station 110. The SCG may be an NR SCG, and triggering SCG RLF may remove one or more NR cells associated with the NR configuration failure. Additionally, or alternatively, as shown by reference number 1020, the UE 120 may refrain from scheduling and/or performing (e.g., may stop, may mute, and/or the like) NR cell measurements. For example, the UE 120 may refrain from measuring one or more NR cells, such as by refraining from performing LTE to NR (L2NR) measurements. Additionally, or alternatively, the UE 120 may refrain from scheduling and/or performing NR cell measurements on one or more NR cells that are impacted by a misconfigured parameter in the NR configuration failure. For example, if a cell-specific parameter has been misconfigured for an NR cell, then the UE 120 may refrain from scheduling and/or performing NR cell measurements for the NR cell. As another example, if a tracking area (TA)-specific parameter has been misconfigured, then the UE 120 may refrain from scheduling and/or performing NR cell measurements for all NR cells in the TA. As another example, if a public land mobile network (PLMN)-specific parameter has been misconfigured, then the UE 120 may refrain from scheduling and/or performing NR cell measurements for all NR cells in the PLMN. In this way, the UE 120 may prevent the addition of an NR secondary cell (SCell), such as a primary SCell (PSCell), due to NR cell measurements, thereby reducing the likelihood of repeated NR configuration failures. In some aspects, the UE 120 may resume measurements of NR cells after a time period has elapsed and/or after the VoLTE call ends. In some aspects, the time period is configurable (e.g., via an RRC message from the base station 110).

Additionally, or alternatively, if the UE 120 receives an instruction from the base station 110 to add an NR cell while the VoLTE call is ongoing (sometimes referred to as a blind PSCell addition request), the UE 120 may ignore the request. For example, the UE 120 may refrain from adding the NR PSCell. However, the UE 120 may transmit a reconfiguration complete message based at least in part on the instruction (e.g., to prevent additional 4G RLF due to an NR configuration failure). In some aspects, the UE 120 may trigger SCG RLF after sending the reconfiguration complete message. In this way, the UE 120 may prevent the addition of an NR cell, such as a PSCell, due to blind PSCell addition, thereby reducing the likelihood of repeated NR configuration failures. In some aspects, the base station 110 may instruct the UE 120 to add an NR PSCell that is different from an NR cell associated with the NR configuration failure. In this case, the UE 120 may add the NR PSCell, and may refrain from scheduling and/or performing (e.g., may stop, may mute, and/or the like) NR cell measurements. For example, the UE 120 may refrain from measuring one or more NR cells, such as by refraining from performing NR to NR (NR2NR) measurements. In some aspects, the UE 120 may refrain from scheduling and/or performing NR cell measurements on one or more NR cells based at least in part on a misconfigured parameter in the NR configuration failure. For example, if a cell-specific parameter has been misconfigured for an NR cell, then the UE 120 may refrain from scheduling and/or performing NR cell measurements for the NR cell. As another example, if a tracking area (TA)-specific parameter has been misconfigured, then the UE 120 may refrain from scheduling and/or performing NR cell measurements for all NR cells in the TA. As another example, if a public land mobile network (PLMN)-specific parameter has been misconfigured, then the UE 120 may refrain from scheduling and/or performing NR cell measurements for all NR cells in the PLMN. In this way, the UE 120 may prevents the addition of the problematic NR cell (and/or prevents the UE 120 from being handed over to the problematic NR cell) after adding the NR cell that is not associated with a configuration issue, thereby reducing the likelihood of repeated NR configuration failures. In some aspects, the UE 120 may resume measurements of NR cells after a time period has elapsed and/or after the VoLTE call ends. In some aspects, the time period is configurable (e.g., via an RRC message from the base station 110).

As shown by reference number 1025, after the VoLTE call ends, the UE 120 may perform a TAU procedure. For example, the UE 120 may transmit a TAU request to the base station 110 based at least in part on determining that the VoLTE call has ended. In this way, the UE 120 may attempt to obtain a correct NR configuration to take advantage of benefits associated with adding NR cells while also avoiding interruption to the VoLTE call that would occur if the TAU procedure is performed while the VoLTE call is ongoing.

As shown by reference number 1030, if the UE 120 is not connected on a VoLTE call when the network configuration procedure has failed the threshold number of times, then the UE 120 may perform a TAU procedure, as described above. For example, the UE 120 may transmit a TAU request to the base station 110 based at least in part on determining that the UE is not connected on a VoLTE call. In this way, the UE 120 may attempt to obtain a correct NR configuration to take advantage of benefits associated with adding NR cells.

In some aspects, after performing the TAU procedure, the UE 120 may transmit a connection request. The base station 110 may transmit a UE capability enquiry based at least in part on receiving the connection request from the UE 120. However, in some cases, the base station 110 may not transmit the UE capability enquiry (e.g., due to some issue with the base station 110 and/or the core network). In this case, as shown by reference number 1035, the UE 120 may determine that the UE 120 has not received a UE capability enquiry after a threshold number of connection requests. If the UE 120 sends a threshold number (e.g., one, two, three, or the like) of connection requests after the TAU procedure and does not receive a UE capability enquiry from the base station 110, then the UE 120 may trigger SCG RLF, may refrain from scheduling and/or performing NR cell measurements (e.g., L2NR measurements, NR2NR measurements, and/or the like), may ignore an instruction from the base station 110 to add an NR cell, and/or the like, as described above.

The techniques described in connection with FIG. 10 may assist with avoiding repeated NR configuration failures without disabling an ENDC capability of the UE 120. In some aspects, other techniques described herein (e.g., in connection with FIG. 5, FIG. 6, and/or the like) may disable an ENDC capability of the UE 120. In some aspects, the UE 120 may perform one or more operations described in connection with FIG. 10 upon detecting a threshold number of NR configuration failures, without disabling an ENDC capability of the UE 120. In some aspects, if NR configuration failures continue to occur after performing these operation(s), the UE 120 may perform one or more operations described elsewhere herein (e.g., in connection with FIG. 5, FIG. 6, and/or the like) to disable an ENDC capability of the UE 120 and prevent further NR configuration failures.

As indicated above, FIG. 10 is provided as an example. Other examples may differ from what is described with respect to FIG. 10.

FIG. 11 is a diagram illustrating an example process 1100 performed, for example, by a UE, in accordance with various aspects of the present disclosure. Example process 1100 is an example where a UE (e.g., UE120 and/or the like) performs operations associated with handling repeated network configuration failure.

As shown in FIG. 11, in some aspects, process 1100 may include determining that a network configuration procedure has failed a threshold number of times for a first radio access technology (RAT) (block 1110). For example, the UE (e.g., using receive processor 258, transmit processor 264, controller/processor 280, memory 282, and/or the like) may determine that a network configuration procedure has failed a threshold number of times for a first radio access technology (RAT), as described above.

As further shown in FIG. 11, in some aspects, process 1100 may include performing a first action to prevent execution of the network configuration procedure until a timer has elapsed based at least in part on determining that the network configuration procedure has failed the threshold number of times, wherein the first action comprises at least one of: transmitting a message that indicates that the UE does not have a capability to communicate using the first RAT, barring a cell or a tracking area of the first RAT or a second RAT that assists with establishing a radio access network connection for the first RAT, refraining from reporting measurement results for the first RAT, or a combination thereof (block 1120). For example, the UE (e.g., using receive processor 258, transmit processor 264, controller/processor 280, memory 282, and/or the like) may perform a first action to prevent execution of the network configuration procedure until a timer has elapsed, as described above. In some aspects, the UE may perform the first action based at least in part on determining that the network configuration procedure has failed the threshold number of times. In some aspects, the first action may include at least one of: transmitting a message that indicates that the UE does not have a capability to communicate using the first RAT, barring a cell or a tracking area of the first RAT or a second RAT that assists with establishing a radio access network connection for the first RAT, refraining from reporting measurement results for the first RAT, or a combination thereof.

Process 1100 may include additional aspects, such as any single aspect or any combination of aspects described below and/or in connection with one or more other processes described elsewhere herein.

In a first aspect, process 1100 includes determining that the timer has elapsed; and performing a second action to permit execution of the network configuration procedure based at least in part on determining that the timer has elapsed, wherein the second action comprises at least one of: transmitting a message that indicates that the UE has a capability to communicate using the first RAT, debarring a cell or a tracking area of the first RAT or the second RAT, reporting one or more measurement results for the first RAT, or a combination thereof.

In a second aspect, alone or in combination with the first aspect, the first action further comprises disabling a radio capability for the first RAT.

In a third aspect, alone or in combination with one or more of the first and second aspects, the first action comprises: transmitting a first tracking area update request that includes a UE radio capability information update needed information element (IE); receiving a first UE capability enquiry based at least in part on transmitting the first tracking area update request that includes the UE radio capability update needed IE; and transmitting the message that indicates that the UE does not have a capability to communicate using the first RAT based at least in part on receiving the first UE capability enquiry, wherein the message is a first UE capability information message that indicates that the UE does not have a radio capability for at least one of the first RAT or dual connectivity with the first RAT and the second RAT.

In a fourth aspect, alone or in combination with one or more of the first through third aspects, process 1100 includes determining that the timer has elapsed; transmitting a second tracking area update request that includes the UE radio capability information update needed IE based at least in part on determining that the timer has elapsed; receiving a second UE capability enquiry based at least in part on transmitting the second tracking area update request that includes the UE radio capability update needed IE; and transmitting a message that indicates that the UE has a capability to communicate using the first RAT based at least in part on receiving the second UE capability enquiry, wherein the message that indicates that the UE has a capability to communicate using the first RAT is a second UE capability information message that indicates that the UE has a radio capability for at least one of the first RAT or dual connectivity with the first RAT and the second RAT.

In a fifth aspect, alone or in combination with one or more of the first through fourth aspects, the first action comprises transmitting the message that indicates that the UE does not have a capability to communicate using the first RAT, wherein the message is a first tracking area update request that indicates that the UE does not have a UE network capability that supports dual connectivity for the first RAT and the second RAT.

In a sixth aspect, alone or in combination with one or more of the first through fifth aspects, process 1100 includes determining that the timer has elapsed; and transmitting a second tracking area update request that indicates that the UE has a UE network capability that supports dual connectivity for the first RAT and the second RAT based at least in part on determining that the timer has elapsed.

In a seventh aspect, alone or in combination with one or more of the first through sixth aspects, the first action comprises: barring the cell of the first RAT or the second RAT; and selecting another cell of the first RAT, the second RAT, or a third RAT.

In an eighth aspect, alone or in combination with one or more of the first through seventh aspects, process 1100 includes determining that the timer has elapsed, wherein the timer is specific to the cell; and debarring the cell based at least in part on determining that the timer has elapsed.

In a ninth aspect, alone or in combination with one or more of the first through eighth aspects, the first action comprises: barring the tracking area of the first RAT or the second RAT; and selecting another cell of the first RAT, the second RAT, or a third RAT. In some aspects, the other cell is included in a different tracking area than the tracking area.

In a tenth aspect, alone or in combination with one or more of the first through ninth aspects, process 1100 includes determining that the timer has elapsed, wherein the timer is specific to the tracking area; and debarring the tracking area based at least in part on determining that the timer has elapsed.

In an eleventh aspect, alone or in combination with one or more of the first through tenth aspects, the first action comprises refraining from reporting measurement results for the first RAT; and process 1100 includes determining that the timer has elapsed, and reporting one or more measurement results for the first RAT based at least in part on determining that the timer has elapsed.

In a twelfth aspect, alone or in combination with one or more of the first through eleventh aspects, the first action comprises triggering secondary cell group radio link failure and refraining from reporting measurement results for the first RAT based at least in part on determining that a voice call is ongoing on the second RAT; and performing a tracking area update procedure based at least in part on determining that the voice call has ended.

In a thirteenth aspect, alone or in combination with one or more of the first through twelfth aspects, the first action comprises performing a tracking area update procedure based at least in part on determining that a voice call is not ongoing on the second RAT; and triggering secondary cell group radio link failure and refraining from reporting measurement results for the first RAT based at least in part on determining that a UE capability enquiry has not been received in connection with performing the tracking area update procedure.

In a fourteenth aspect, alone or in combination with one or more of the first through thirteenth aspects, the UE is operating in a standalone mode with the first RAT.

In a fifteenth aspect, alone or in combination with one or more of the first through thirteenth aspects, the UE is operating in a non-standalone mode with the first RAT and the second RAT.

In a sixteenth aspect, alone or in combination with one or more of the first through fifteenth aspects, process 1100 includes determining one or more cells that are impacted by a misconfigured parameter of the network configuration procedure; and refraining from reporting measurement results for the one or more cells.

In a seventeenth aspect, alone or in combination with one or more of the first through sixteenth aspects, the network configuration procedure is a radio resource control connection reconfiguration procedure.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
determining that a network configuration procedure has failed a threshold number of times for a first radio access technology (RAT); and
performing a first action to prevent execution of the network configuration procedure until a timer has elapsed based at least in part on determining that the network configuration procedure has failed the threshold number of times, wherein the first action comprises at least one of:
transmitting a message that indicates that the UE does not have a capability to communicate using the first RAT,
barring a cell or a tracking area of the first RAT or a second RAT that assists with establishing a radio access network connection for the first RAT,
refraining from reporting measurement results for the first RAT, or
a combination thereof.

2. The method of claim 1, further comprising:
determining that the timer has elapsed; and
performing a second action to permit execution of the network configuration procedure based at least in part on determining that the timer has elapsed, wherein the second action comprises at least one of:
transmitting a message that indicates that the UE has a capability to communicate using the first RAT,
debarring a cell or a tracking area of the first RAT or the second RAT,
reporting one or more measurement results for the first RAT, or
a combination thereof.

3. The method of claim 1, wherein the first action further comprises disabling a radio capability for the first RAT.

4. The method of claim 1, wherein the first action comprises:
transmitting a first tracking area update request that includes a UE radio capability information update needed information element (IE);
receiving a first UE capability enquiry based at least in part on transmitting the first tracking area update request that includes the UE radio capability update needed IE; and
transmitting the message that indicates that the UE does not have a capability to communicate using the first RAT based at least in part on receiving the first UE capability enquiry, wherein the message is a first UE capability information message that indicates that the UE does not have a radio capability for at least one of the first RAT or dual connectivity with the first RAT and the second RAT.

5. The method of claim 4, further comprising:
determining that the timer has elapsed;
transmitting a second tracking area update request that includes the UE radio capability information update needed IE based at least in part on determining that the timer has elapsed;
receiving a second UE capability enquiry based at least in part on transmitting the second tracking area update request that includes the UE radio capability update needed IE; and
transmitting a message that indicates that the UE has a capability to communicate using the first RAT based at least in part on receiving the second UE capability enquiry, wherein the message that indicates that the UE has a capability to communicate using the first RAT is a second UE capability information message that indicates that the UE has a radio capability for at least one of the first RAT or dual connectivity with the first RAT and the second RAT.

6. The method of claim 1, wherein the first action comprises transmitting the message that indicates that the UE does not have a capability to communicate using the first RAT, wherein the message is a first tracking area update request that indicates that the UE does not have a UE network capability that supports dual connectivity for the first RAT and the second RAT.

7. The method of claim 6, further comprising:
determining that the timer has elapsed; and
transmitting a second tracking area update request that indicates that the UE has a UE network capability that supports dual connectivity for the first RAT and the second RAT based at least in part on determining that the timer has elapsed.

8. The method of claim 1, wherein the first action comprises:
barring the cell of the first RAT or the second RAT; and
selecting another cell of the first RAT, the second RAT, or a third RAT.

9. The method of claim 8, further comprising:
determining that the timer has elapsed, wherein the timer is specific to the cell; and
debarring the cell based at least in part on determining that the timer has elapsed.

10. The method of claim 1, wherein the first action comprises:
barring the tracking area of the first RAT or the second RAT; and
selecting another cell of the first RAT, the second RAT, or a third RAT, wherein the other cell is included in a different tracking area than the tracking area.

11. The method of claim 10, further comprising:
determining that the timer has elapsed, wherein the timer is specific to the tracking area; and
debarring the tracking area based at least in part on determining that the timer has elapsed.

12. The method of claim 1, wherein the first action comprises refraining from reporting measurement results for the first RAT; and
wherein the method further comprises:
determining that the timer has elapsed; and
reporting one or more measurement results for the first RAT based at least in part on determining that the timer has elapsed.

13. The method of claim 1, wherein the first action comprises triggering secondary cell group radio link failure and refraining from reporting measurement results for the first RAT based at least in part on determining that a voice call is ongoing on the second RAT; and
performing a tracking area update procedure based at least in part on determining that the voice call has ended.

14. The method of claim 1, wherein the first action comprises performing a tracking area update procedure based at least in part on determining that a voice call is not ongoing on the second RAT; and
triggering secondary cell group radio link failure and refraining from reporting measurement results for the first RAT based at least in part on determining that a UE capability enquiry has not been received in connection with performing the tracking area update procedure.

15. The method of claim 1, wherein the first action comprises:
determining one or more cells that are impacted by a misconfigured parameter of the network configuration procedure; and
refraining from reporting measurement results for the one or more cells.

16. The method of claim 1, wherein the UE is operating in a standalone mode with the first RAT or is operating in a non-standalone mode with the first RAT and the second RAT.

17. A user equipment (UE) for wireless communication, comprising:
a memory; and
one or more processors operatively coupled to the memory, the memory and the one or more processors configured to:
determine that a network configuration procedure has failed a threshold number of times for a first radio access technology (RAT); and
perform a first action to prevent execution of the network configuration procedure until a timer has elapsed based at least in part on determining that the network configuration procedure has failed the threshold number of times, wherein the first action comprises at least one of:
transmitting a message that indicates that the UE does not have a capability to communicate using the first RAT,
barring a cell or a tracking area of the first RAT or a second RAT that assists with establishing a radio access network connection for the first RAT,
refraining from reporting measurement results for the first RAT, or
a combination thereof.

18. The UE of claim 17, wherein the one or more processors are further configured to:
determine that the timer has elapsed; and
perform a second action to permit execution of the network configuration procedure based at least in part on determining that the timer has elapsed, wherein the second action comprises at least one of:
transmitting a message that indicates that the UE has a capability to communicate using the first RAT,
debarring a cell or a tracking area of the first RAT or the second RAT, reporting one or more measurement results for the first RAT, or
a combination thereof.

19. The UE of claim 17, wherein the first action further comprises disabling a radio capability for the first RAT.

20. The UE of claim 17, wherein the first action comprises:
transmitting a first tracking area update request that includes a UE radio capability information update needed information element (IE);
receiving a first UE capability enquiry based at least in part on transmitting the first tracking area update request that includes the UE radio capability update needed IE; and
transmitting the message that indicates that the UE does not have a capability to communicate using the first RAT based at least in part on receiving the first UE capability enquiry, wherein the message is a first UE capability information message that indicates that the UE does not have a radio capability for at least one of the first RAT or dual connectivity with the first RAT and the second RAT.

21. The UE of claim 20, wherein the one or more processors are further configured to:
determine that the timer has elapsed;
transmit a second tracking area update request that includes the UE radio capability information update needed IE based at least in part on determining that the timer has elapsed;
receive a second UE capability enquiry based at least in part on transmitting the second tracking area update request that includes the UE radio capability update needed IE; and
transmit a message that indicates that the UE has a capability to communicate using the first RAT based at least in part on receiving the second UE capability enquiry, wherein the message that indicates that the UE has a capability to communicate using the first RAT is a second UE capability information message that indicates that the UE has a radio capability for at least one of the first RAT or dual connectivity with the first RAT and the second RAT.

22. The UE of claim 17, wherein the first action comprises transmitting the message that indicates that the UE does not have a capability to communicate using the first RAT, wherein the message is a first tracking area update request that indicates that the UE does not have a UE network capability that supports dual connectivity for the first RAT and the second RAT.

23. The UE of claim 22, wherein the one or more processors are further configured to:
determine that the timer has elapsed; and
transmit a second tracking area update request that indicates that the UE has a UE network capability that supports dual connectivity for the first RAT and the second RAT based at least in part on determining that the timer has elapsed.

24. The UE of claim 17, wherein the first action comprises:
barring the cell of the first RAT or the second RAT; and
selecting another cell of the first RAT, the second RAT, or a third RAT.

25. The UE of claim 24, wherein the one or more processors are further configured to:
determine that the timer has elapsed, wherein the timer is specific to the cell; and
debar the cell based at least in part on determining that the timer has elapsed.

26. The UE of claim 17, wherein the first action comprises:
barring the tracking area of the first RAT or the second RAT; and
selecting another cell of the first RAT, the second RAT, or a third RAT, wherein the other cell is included in a different tracking area than the tracking area.

27. The UE of claim 26, wherein the one or more processors are further configured to:
determine that the timer has elapsed, wherein the timer is specific to the tracking area; and
debar the tracking area based at least in part on determining that the timer has elapsed.

28. The UE of claim 17, wherein the first action comprises refraining from reporting measurement results for the first RAT; and
wherein the one or more processors are further configured to:
determine that the timer has elapsed; and
report one or more measurement results for the first RAT based at least in part on determining that the timer has elapsed.

29. A non-transitory computer-readable medium storing one or more instructions for wireless communication, the one or more instructions comprising:
one or more instructions that, when executed by one or more processors of a user equipment (UE), cause the one or more processors to:
determine that a network configuration procedure has failed a threshold number of times for a first radio access technology (RAT); and
perform a first action to prevent execution of the network configuration procedure until a timer has elapsed based at least in part on determining that the network configuration procedure has failed the threshold number of times, wherein the first action comprises at least one of:
transmitting a message that indicates that the UE does not have a capability to communicate using the first RAT,
barring a cell or a tracking area of the first RAT or a second RAT that assists with establishing a radio access network connection for the first RAT,
refraining from reporting measurement results for the first RAT, or
a combination thereof.

30. An apparatus for wireless communication, comprising:
means for determining that a network configuration procedure has failed a threshold number of times for a first radio access technology (RAT); and
means for performing a first action to prevent execution of the network configuration procedure until a timer has elapsed based at least in part on determining that the network configuration procedure has failed the threshold number of times, wherein the first action comprises at least one of:
transmitting a message that indicates that the apparatus does not have a capability to communicate using the first RAT,
barring a cell or a tracking area of the first RAT or a second RAT that assists with establishing a radio access network connection for the first RAT,
refraining from reporting measurement results for the first RAT, or
a combination thereof.
